(19) United States
(12) Patent Application Publication
(10) Pub. No.: US 2025/0378255 A1
(43) Pub. Date: Dec. 11, 2025

(54) METHOD FOR OPTIMAL PLACEMENT AND ROUTING OF TRANSISTORS

(71) Applicants: SK Hynix Inc., Icheon-si (KR); POSTECH RESEARCH AND BUSINESS DEVELOPMENT FOUNDATION, Pohang-si (KR)

(72) Inventors: Hyun Kyu KIM, Icheon-si (KR); Tae Wook KANG, Icheon-si (KR); Joon Rak KIM, Icheon-si (KR); Si Jeo PARK, Icheon-si (KR); Dong Gu CHOI, Pohang-si (KR); Byung In KIM, Pohang-si (KR); Hyung Jun PARK, Pohang-si (KR); Beom Hi LEE, Pohang-si (KR); Sun Jin HAN, Pohang-si (KR)

(21) Appl. No.: 18/930,102

(22) Filed: Oct. 29, 2024

(30) Foreign Application Priority Data
Jun. 11, 2024 (KR) 10-2024-0075681

(51) Int. Cl. G06F 30/398; G06F 30/392

(52) U.S. Cl. CPC G06F 30/398; G06F 30/392

(57) ABSTRACT

Disclosed is a method for automating optimal placement and routing of transistors, in which in order to minimize a layout area, diversify a layout structure, and achieve routing optimization, electrical connection information of transistors constituting a circuit and parameters of the transistors are used to primarily place the transistors, heuristic-based pattern optimization and priority are determined, and then the transistors are placed and routed in an optimized state according to the above determination.

### CROSS-REFERENCE TO RELATED APPLICATION

This application claims priority under 35 U.S.C. § 119 to Korean Patent Application No. 10-2024-0075681 filed on Jun. 11, 2024, which is incorporated herein by reference in its entirety.

### BACKGROUND

### 1. Field

Exemplary embodiments relate to circuit layout automation, and particularly, to a method for optimal placement and routing of transistors.

### 2. Discussion of the Related Art

A digital integrated circuit is a circuit that operates using binary values of 0 (zero) or 1 (one). The performance of such a circuit can be influenced by process mismatches between transistors, between passive elements, and/or between transistors and passive elements, parasitic capacitance thereof, and parasitic capacitance between metal lines connecting transistors and passive elements and a substrate. These factors can significantly affect an output value generated in a specific circuit of the digital integrated circuit.

Unlike the digital integrated circuit, an analog integrated circuit represents a range of continuous values between a maximum value and a minimum value, in terms of voltage or current, rather than binary values. As a result, process mismatches and parasitic capacitance can have a significant adverse influence on an output value of an analog circuit. Therefore, these factors need to be considered during the manufacturing process of an analog semiconductor device.

For example, the etching depth of a pattern surface can vary depending on the presence or absence of other patterns within a certain proximity. This variance occurs because the etching rate for a specific pattern surface is influenced by its surrounding environment, with surfaces surrounded by other patterns generally experiencing a lower etching rate than those without surrounding patterns. Consequently, even when identical patterns are implemented in different locations, the physical form of the pattern can differ based on its location. As a result, transistors (TR) designed with the same pattern can exhibit differences (mismatches) in their electrical characteristics.

In general, capacitors are used in various analog circuits. In order to reduce process-induced mismatches between capacitors, or to minimize the impact of such mismatches when they occur, a common centroid layout (CCL) technique is often used for the capacitors. However, even when capacitors are designed with an optimal area using the CCL technique, complications can arise if metal lines electrically connecting the capacitors are complex. This can lead to an increase in an area occupied by the metal lines in the layout, as well as additional issues with parasitic capacitance between the metal lines and a substrate.

A current mirror operates by applying the same voltage level to gates of two transistors (TRs), thereby mirroring a current flowing through one TR to the other TR. For the current mirror to achieve the desired electrical characteristics, it is essential that the gate lengths and gate widths of the two TRs are identical. To ensure this uniformity, the CCL technique can be applied during the layout design.

A circuit designer begins the design process by creating a schematic that represents transistors and passive elements using symbols. In the following description, it is assumed that the schematic is a circuit diagram that uses symbols to represent TRs and passive elements, such as resistors and capacitors.

The CCL technique can be applied when implementing a schematic that includes a plurality of TRs and a plurality of passive elements in a layout. In such a case, the circuit designer may designate TRs and passive elements to which the CCL technique should be applied, and then a layout operator implements a layout by applying the CCL technique to the designated TRs and passive elements.

When the layout operator applies the CCL technique to an element at the request of the circuit designer, it is fully predictable that the layout results may vary depending on the operator's personal experience and skills. In addition, when the layout operator not only applies the CCL technique to place elements but also takes into account both the resistance due to the length of the metal lines connecting the elements and the capacitance between the metal lines and a substrate, the circuit designer's requirements are more likely to be met.

As described above, when all layout work is performed manually, a significant amount of manpower and time is required, which presents a notable drawback.

### SUMMARY

Various embodiments are directed to providing a method for automating optimal placement and routing of transistors. This method aims to minimize a layout area, diversify a layout structure, and achieve routing optimization by using electrical connection information and parameters of transistors in a circuit for initial placement. Heuristic-based pattern optimization and prioritization are then determined, and the transistors are subsequently placed and routed in an optimized configuration based on these determinations.

Technical problems to be achieved in the present disclosure are not limited to the aforementioned technical problems and the other unmentioned technical problems will be clearly understood by those skilled in the art from the following description.

A method for optimal placement and routing of transistors according to the present disclosure includes: extracting parameters and connection information of transistors (TRs) from a netlist file; generating an initial placement structure of entire TRs on the basis of mathematical model optimization by using the parameters and connection information of the TRs; heuristic rule setting including layout rules of assigning work priorities for common centroid transistor pair (CCT pair), TR pattern, and routing optimization on the basis of the initial placement structure of the entire TR; and deriving optimal placement and routing results by performing TR placement and routing a plurality of times according to the layout rules and applying an evaluation of fitness function to respective execution results.

In accordance with a method for optimal placement and routing of transistors according to the present disclosure as described above, optimal transistor placement and optimal routing can be automatically implemented using only information included in a netlist that can be easily generated using a schematic circuit produced by a designer, so that it is possible to minimize a layout area, diversify a placement structure, and optimize routing regardless of designer's experience.

Effects achievable in the disclosure are not limited to the aforementioned effects and the other unmentioned effects will be clearly understood by those skilled in the art from the following description.

### BRIEF DESCRIPTION OF THE DRAWINGS

FIG. 1 illustrates a method for automating optimal placement and routing of transistors according to an embodiment of the present disclosure.

FIG. 2 illustrates a schematic circuit diagram and a netlist thereof.

FIG. 3 illustrates an example of a two-dimensional (2D) placement pattern.

FIG. 4 illustrates a placement structure using only a 1D pattern.

FIG. 5 illustrates a placement structure using a 2D pattern together with a 1D pattern.

FIGS. 6A and 6B illustrate examples of defining a minimum space related to placement conditions.

FIGS. 7A and 7B illustrate other examples of defining a minimum space related to placement conditions.

FIG. 8 illustrates an example of applying rules of priorities assigned to transistor placement.

### DETAILED DESCRIPTION

In order to fully understand the present disclosure, advantages in operation of the present disclosure, and objects achieved by carrying out the present disclosure, the accompanying drawings for explaining exemplary embodiments of the present disclosure and the contents described with reference to the accompanying drawings need to be referred to.

Hereinafter, the present disclosure is described in detail by describing preferred embodiments of the present disclosure with reference to the accompanying drawings. The same reference numerals among the reference numerals in each drawing indicate the same members.

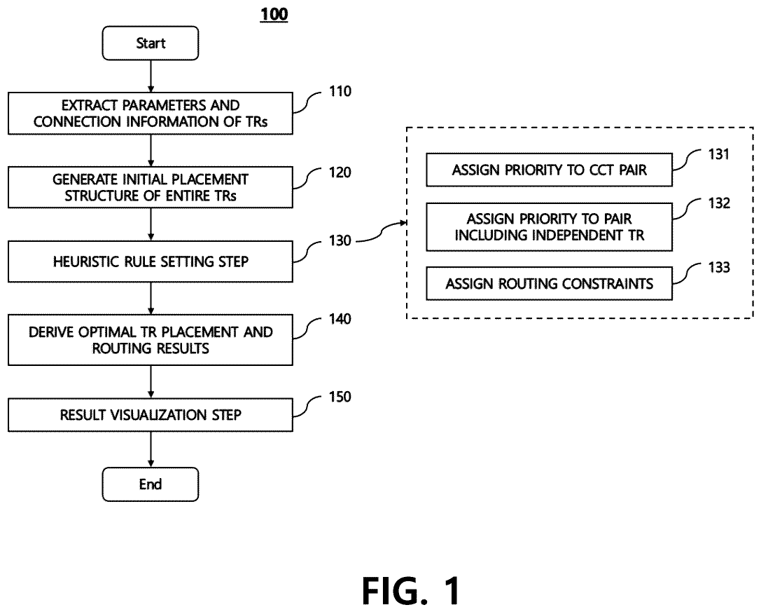

FIG. 1 illustrates a method 100 for automating optimal placement and routing of transistors according to an embodiment of the present disclosure.

Referring to FIG. 1, the method 100 includes step 110 of extracting parameters and connection information of transistors (TRs), step 120 of generating an initial placement structure of all TRs, heuristic rule setting step 130, step 140 of deriving optimal TR placement and routing results, and result visualization step 150.

The method 100 may be implemented with hardware including a plurality of functional blocks that perform respective steps illustrated in FIG. 1. For example, the method 100 can be implemented using a processor such as a digital signal processor.

In step 110, TR parameters including the gate width and gate length of a TR in a netlist file and an electrical connection relationship among a gate, a source, a drain, and a bulk constituting the TR are extracted.

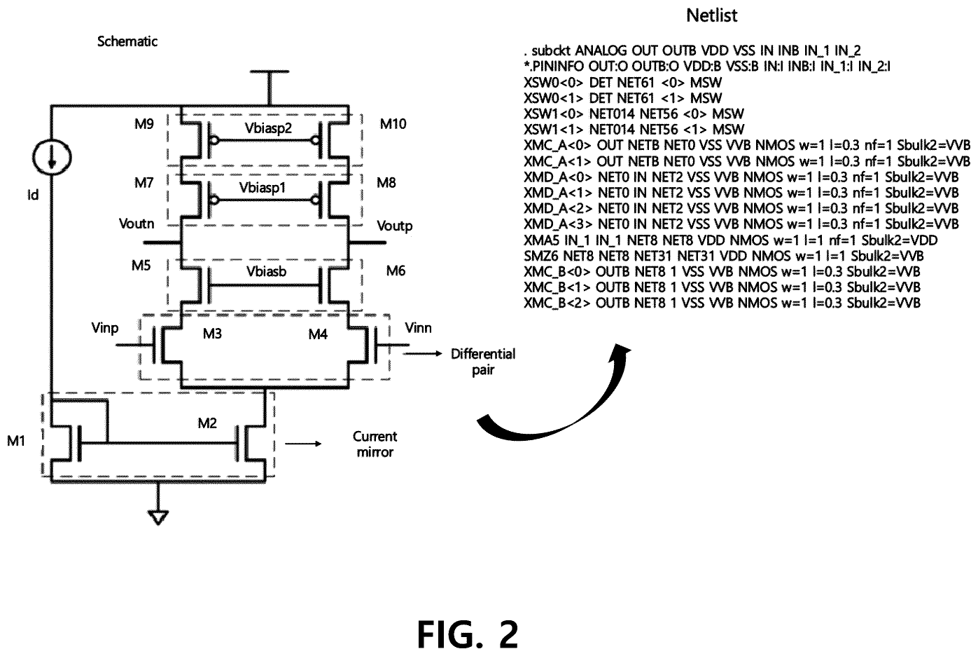

FIG. 2 illustrates a schematic circuit diagram and a netlist thereof.

Referring to FIG. 2, the schematic circuit diagram provides symbols representing elements, such as TRs and a current source, constituting a circuit and an electrical connection relationship between the symbols, and the netlist provides separate names given to the symbols and input/output terminals constituting the symbols. The schematic circuit diagram and the netlist represent the same circuit in different forms. The schematic is designed for visual inspection by a designer, while the netlist is optimized for signal processing by a computational process.

In step 120, the initial placement structure of all TRs is generated based on mathematical model optimization, using the parameters and connection information of each TR extracted in step 110.

First, x and y coordinates are assigned to each TR pattern using the parameters of the TRs. The y-axis positions of the TRs are aligned by introducing the degree of splitting and a row concept. Mathematical variables based on the placement of the aligned TRs are then applied. Finally, an initial placement structure for all TRs is primarily generated using an estimated routing value of each TR.

Assuming that the TRs are aligned along the y-axis, the mathematical variables include a width (e.g., tw_{AB}) and a length (e.g., pI_{AB}) of gates of two TRs (A and B) that form a TR pair, a distance (e.g., d_{AB}) between two TR pairs (AB and BA) implementing the common centroid layout (CCL), a value (ζ) indicating whether two rows are used, and a distance (e.g., d2_{AB}) between the rows. Here, A and B may represent gates of different TRs, respectively, or may represent the splitting of a gate of a single TR into two.

The present disclosure proposes to satisfy the following conditions when the initial placement structure of all TRs is generated.

First, TR placement-related constraints are complied with the following priority.

1) Among TRs placed in the same row, matching the coordinates of all TRs in the gate direction to align with a TR that has the maximum width.

2) When a two-dimensional (2D) TR pattern is used in the same row and a TR has a short gate length, defining a space with a neighboring TR. It is preferable to leave a space that is twice the minimum required distance between 2D neighbors.

3) Allowing gate lengths of TRs located to the left and right of a common centroid transistor (CCT) to be equal to the gate length of the CCT.

4) When a connection relationship exists, placing TRs located in different rows around a virtual line.

5) Placing TRs that are not part of a common centroid (CC) layout in a finger structure.

6) Determining whether to place a 2D common centroid (CC) pattern in two rows or one row based on the gate width of a TR. Preferably, the 2D CC pattern should be distributed and placed in two rows.

In addition, in step 120, when generating the initial placement structure of all TRs, it is proposed to generate a 2D placement pattern only if the number of TRs in the given netlist is a power of 2.

Two cases are considered: the first case involves generating a 2D placement pattern without splitting each TR, while the second case involves generating a 2D placement pattern after splitting each TR once.

The reference coordinate of the 2D placement pattern is based on the lower-left coordinate of the second row, similar to a one-dimensional (1D) placement pattern located in the first row. The first row is considered as a dummy TR and is included in the placement.

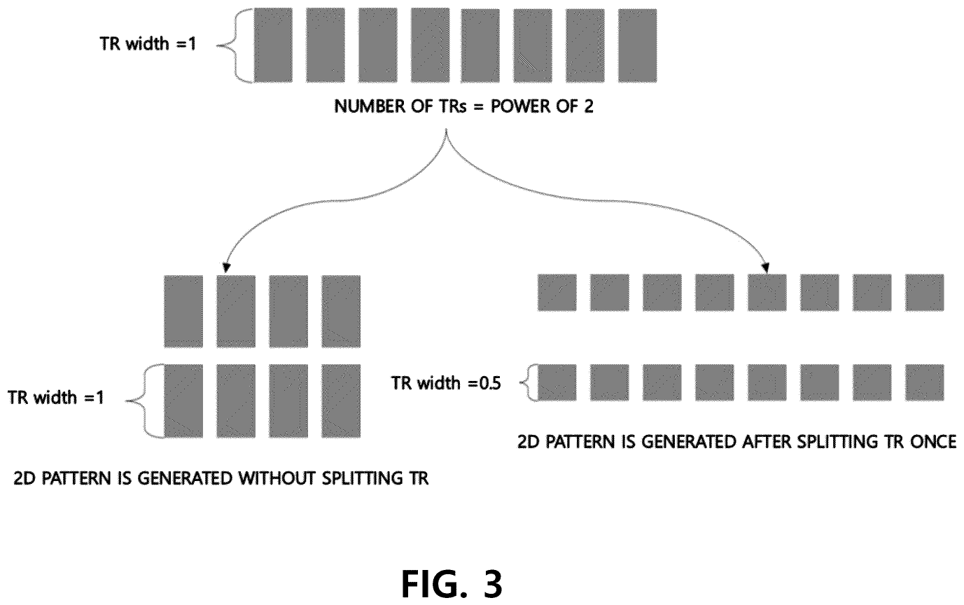

FIG. 3 illustrates an example of a 2D placement pattern.

In FIG. 3, the upper part illustrates four basic TR patterns in which the number of TRs is a power of 2, the lower left illustrates a 2D pattern generated without splitting the TRs, and the lower right illustrates a 2D pattern generated after splitting the TRs once.

Assuming that the width of the basic TR pattern (top), that is, the length in the y-axis direction is 1, it can be seen that the width of the TR when a 2D pattern is formed without splitting the basic TR pattern (lower left) is 1 and the width of the TR when a 2D pattern is formed after splitting the TR once (lower right) is 0.5. For convenience of explanation, width values illustrated in FIG. 3 indicate relative width ratios.

The present disclosure introduces the concept of rows for analyzing 2D patterns.

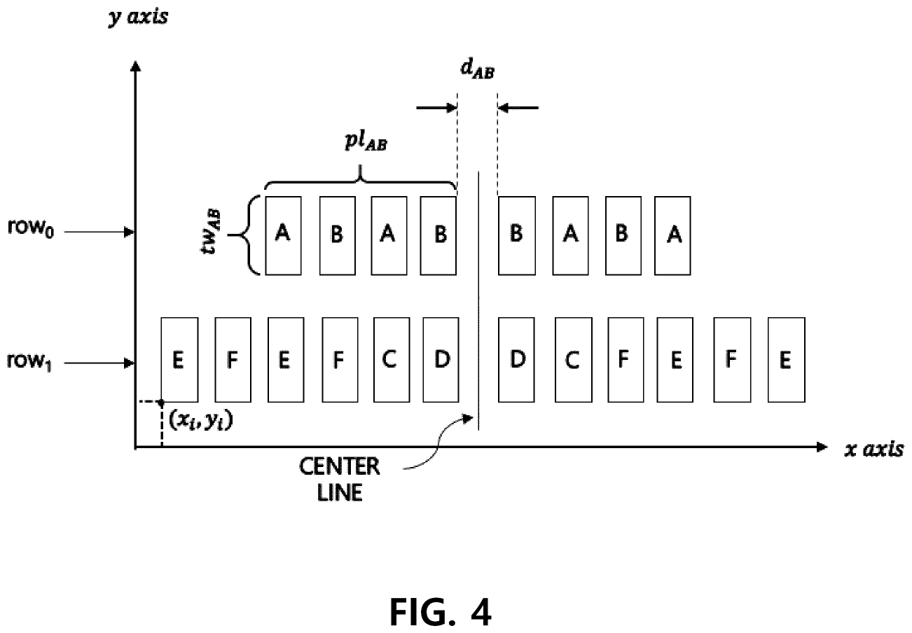

FIG. 4 illustrates an example of a placement structure using only a 1D pattern.

Referring to FIG. 4, two TRs A and B are arranged in a 0^{th} row row₀ and four TRs C to F are arranged in a first row row₁. That is, since each TR is arranged in a single row, the six TRs A to F can be considered to form a 1D (Dimension) pattern. For convenience of explanation, FIG. 4 is based on the assumption that the lengths of gates, specifically the lengths of the gates in the x-axis direction, are the same for all six TRs.

In the case of CCL illustrated in FIG. 4, it can be seen that the two TRs A and B arranged in the 0^{th} row row₀ are symmetric with respect to a center line, with ABAB on the left and BABA on the right. Similarly, in the first row row₁, the four TRs C to F are also symmetric with respect to the center line, with EFEFCD on the left and DCFEFE on the right.

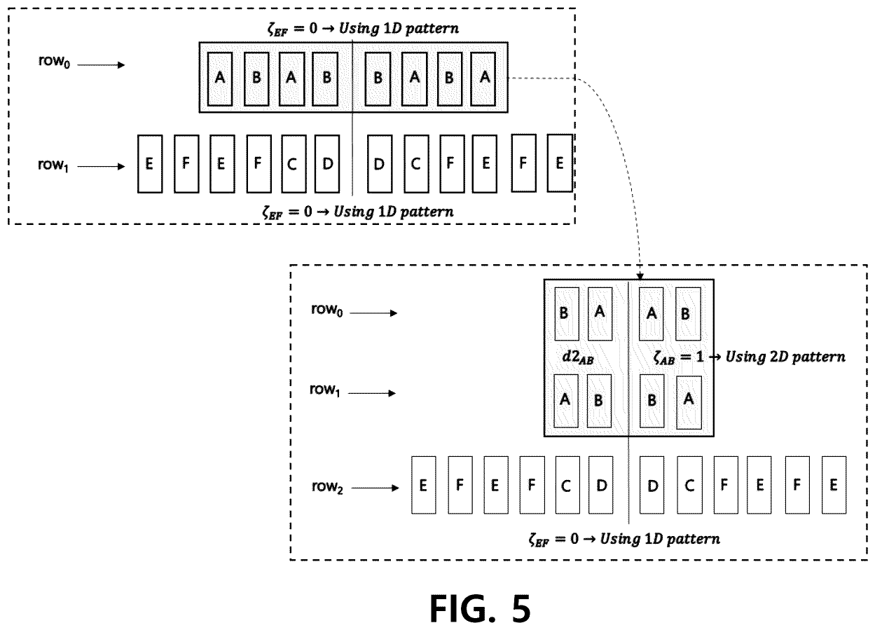

FIG. 5 illustrates a placement structure using a 2D pattern together with a 1D pattern.

For convenience of explanation, the 1D placement structure illustrated in FIG. 4 is shown in the upper part of FIG. 5, while a mixed 1D & 2D placement structure is shown in the lower part of FIG. 5.

The example of FIG. 5 is different from the example illustrated in FIG. 4 in that the two TRs A and B are distributed across two rows, namely, the 0^{th} row row₀ and the first row row₁. However, it is similar to the example illustrated in FIG. 4 in that the four TRs C to F are arranged in a single row, specifically a second row row₂.

In FIG. 5, the two TRs A and B are arranged in a 2D pattern, being distributed across the 0^{th} row row₀ and the first row row₁, while the four TRs C to F is arranged in a 1D pattern. Therefore, the example in FIG. 5 represents a combination of 1D & 2D placement structures.

The definition of minimum space related to placement conditions is described below. To facilitate understanding, a unit placement group is assumed. The unit placement group can be understood as a portion of the initial placement structure of all TRs.

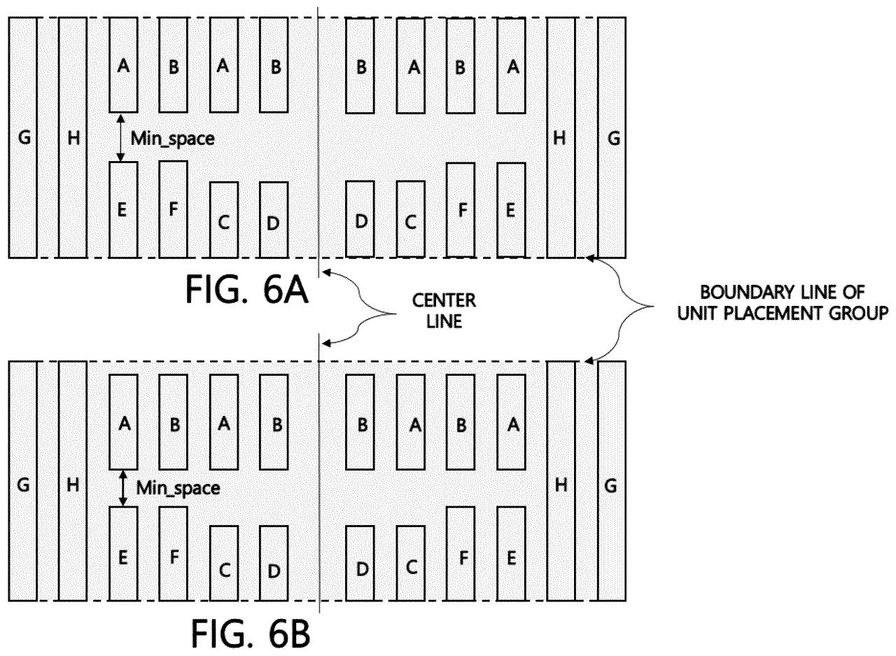

FIGS. 6A and 6B illustrate examples of defining a minimum space related to placement conditions.

For convenience of explanation, it is assumed that a unit placement group within a rectangle includes a total of 8 TRs A to H. In FIGS. 6A and 6B, a gate width of the TR extends in a vertical direction, while a gate length extends in a horizontal direction, with respect to the orientation of FIGS. 6A and 6B. For convenience of explanation, all gate lengths are assumed to be identical.

In FIGS. 6A and 6B, two TRs A and B at the top are arranged symmetrically to each other about a virtual center line, four TRs C to F at the bottom are also arranged symmetrically to each other about the virtual center line, and two TRs G and H on both sides are also arranged symmetrically to each other about the virtual center line.

An arbitrary boundary line (represented by a dotted line) of the unit placement group is a virtual boundary line including the two TRs G and H, which have the longest gate width among the eight TRs A to H.

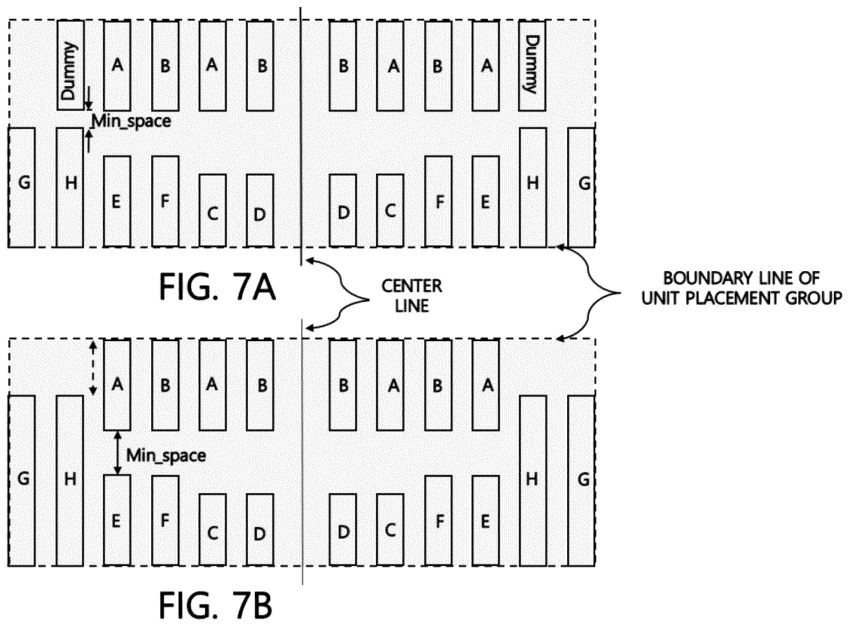

The above description is equally applied to FIGS. 7A and 7B to be described below.

Referring to FIGS. 6A and 6B, it can be seen that the gate widths of the plurality of TRs A to H included in the unit placement group are different from one another. The TRs A to F may be arranged at the top and bottom because the gate widths of the TRs A to F are shorter than those of the TRs G and H. In contrast, the TRs G and H are configured as single stages because the gate widths of the TRs G and H are relatively longer than those of the TRs A to F.

FIG. 6A illustrates an example in which the TRs A and E, placed at the top and bottom respectively, are in contact with the boundary line of the unit placement group due to their relatively short gate widths, and FIG. 6B illustrates an example in which the TRs A and E are located inside the boundary line of the unit placement group.

There are some differences between the unit placement groups illustrated in FIGS. 6A and 6B. FIG. 6B illustrates an example where the gate width of the TR H, which has the longest gate width among the TRs A to H in the unit placement group, is greater than the sum of the widths of the two TRs A and E (A+E) plus a minimum space Min_space between the two TRs A and E. The two TRs A and E are adjacent to each other in the vertical direction, and the two TRs A and E are adjacent to the TR H in the horizontal direction. In FIGS. 6A and 6B, the TRs E and F each have a longer gate width than the TRs C and D.

In the case of the unit placement group illustrated in FIGS. 6A and 6B, a minimum space may be defined based on the TRs E and F, and a space between the TRs A and B and the TRs E and F may be designated as the minimum space Min_space.

FIGS. 7A and 7B illustrate other examples of defining a minimum space related to placement conditions.

FIG. 7 illustrates an example where the gate width of the TR H, which has the longest gate width among the TRs A to H in the unit placement group, is smaller than the sum of the widths of the two TRs A and E (A+E) plus the minimum space Min_space between the two TRs A and E, in contrast to FIGS. 6A and 6B.

In the examples shown in FIGS. 7A and 7B, if the minimum space is determined using the TRs E and F as a reference, as in FIG. 6, an empty space may exist on both sides of the TR A in the horizontal direction. FIGS. 7A and 7B may be distinguished from each other based on whether a dummy pattern Dummy can be added to the empty space to minimize mismatch due to the processing of the TR A.

When the dummy pattern Dummy can be added to both sides of the TR A, as illustrated in FIG. 7A, a space between the dummy pattern Dummy and the TR H in the vertical direction may be determined as the minimum space Min_space. However, when the dummy pattern Dummy cannot be added to both sides of the TR A, as illustrated in FIG. 7B, the mismatch of the TR A cannot be minimized, and it is therefore proposed that such a placement should not be allowed.

When performing the method 100 for optimal placement and routing of transistors according to the present disclosure, information on the dummy pattern Dummy may be determined in advance. For example, a designer may determine the information on the dummy pattern Dummy using netlist information.

By performing step 120 of generating the initial placement structure of all TRs, the initial placement structure of all TRs can be extracted, although it may not be optimal. Once the initial placement structure is extracted, a reference for fine-tuning pattern placement and routing is established by setting work conditions, such as the priority of pattern placement and routing, as described below.

The heuristic rule setting step 130 assigns work priorities to the common centroid transistor pair (CCT pair), TR pattern, and routing optimization. This process includes step 131 of assigning a priority to the CCT pair, step 132 of assigning a priority to a pair that includes an independent TR, and step 133 of assigning routing constraints.

In step 131, the highest priority is assigned to a TR within the CCT pair that is clustered and surrounded in the same row, while the second priority is assigned to a TR located in a different row but paired with the TR assigned the highest priority. Subsequent priorities are assigned to TRs that have an adjacent connection relationship with a TR set that has already been optimized according to the previously assigned priorities. This is done by applying the same process used for assigning the highest and second priorities described above to TRs that have not yet been assigned priorities.

After the highest and second priorities are assigned, if a tie occurs among TRs, a priority is then sequentially assigned to a TR implemented in 2D and to a TR with a relatively larger number of TR fragments. A tie refers to a situation where no clear priority can be determined because multiple solutions have the same target evaluation index from a specific viewpoint.

Step 132 of assigning a priority to a pair including an independent TR is preferably performed after step 131 of assigning a priority to the CCT pair. The TRs are divided into two groups: a first group including a plurality of independent TRs that require the satisfaction of a routing deviation, and a second group including a plurality of independent TRs that do not require the satisfaction of the routing deviation. Priority is assigned to the first group over the second group.

Within each group, routing optimization priority is first assigned to TRs connected to a main TR, such as a CCT TR, and to TRs that include a relatively larger number of TRs and a larger number of TR fragments. Among the TRs connected to the main TR, priority may be relatively assigned to TRs implemented in 2D within the same group.

For example, in the first group, the highest priority is assigned to the TR that requires the satisfaction of the routing deviation. If a tie occurs among the TRs in the first group, priority is sequentially assigned to TR pairs in 2D where the TRs are distributed across multiple rows, followed by the main TR, and then to a TR with a larger number of TR fragments.

Subsequently, in the second group, priority is assigned to TRs that do not require the satisfaction of the routing deviation. Similar to the process for TRs requiring the satisfaction of the routing deviation, if a tie occurs among the TRs, priority is sequentially assigned to TR pairs in 2D that span multiple rows, followed by the main TR, and then to a TR with a larger number of TR fragments.

If a situation arises where routing is not possible after performing optimization in the order described above, the corresponding TR pair is re-optimized with priority. If routing remains impossible even after reordering up to two times, the placement may be deemed an unsolvable situation.

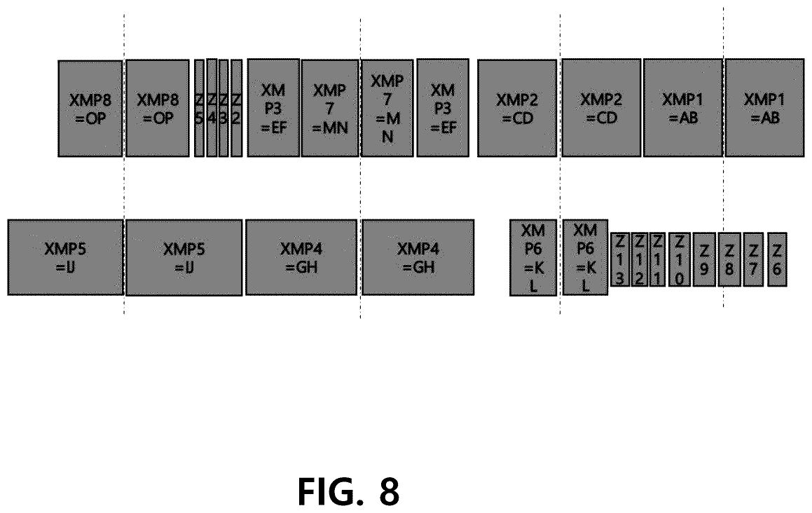

FIG. 8 illustrates an example of applying rules of priorities assigned to TR placement.

Referring to FIG. 8, a CCT pair MN (TRs M and N) that is clustered and surrounded in the center in the same row is defined as a reference. Among TRs connected to the CCT pair MN, a CCT pair GH located in another row is selected, and the CCT pairs MN-GH are defined as a first optimization target.

Subsequently, among TRs adjacently connected to the CCT pairs MN-GH, a CCT pair EF connected to the CCT pair GH across another row is selected and the CCT pairs GH-EF are defined as the next optimization target.

Subsequently, there are many pairs connected to a searched TR, but since all of the pairs are placed in the same row and 2D does not exist, a CCT pair IJ having the largest number of TR fragments is selected and the CCT pairs GH-IJ are defined as the next optimization target.

Since a CCT pair OP is connected to the CCT pair IJ across another row, it is selected as the next ordered pair with priority, and the optimization order is determined in the order of CD-EF, CD-KL, and CD-AB.

The optimization order according to the above description is GH-MN→GH-EF→GH-IJ→IJ-OP→CD-EF→CD-KL→CD-AB.

In step 133, the routing constraints and the routing order are established during the routing process.

First, the routing constraints set to quickly determine the placement structure of the TRs are as follows.

1) For routing pairs requiring pattern matching, matching the number of uses of routing and lengths of a gate layer and first and second metal layers M1 and M2.

2) Matching a 0^{th} metal layer M0 to a length within an allowable deviation. The allowable deviation may be arbitrarily set by an operator for the optimal placement of transistors according to the present disclosure, depending on the specific use case. This deviation refers to the permissible error in the routing length of metal lines that need to be matched.

3) Determining the location of a power line on a layout in advance and preventing metal lines, other than those implementing the power line, from being installed on an upper layer or a lower layer where the power line is placed.

4) Shielding external signals from other signals with high-speed frequencies.

5) Installing a dummy line between metal lines that need to be matched in order to shield the metal lines from each other.

6) When alignment is difficult between two CCT pairs that need to be connected and pins, connecting the two CCT pairs by bending the 0^{th} metal layer M0, which typically has a straight line shape at a certain angle.

7) Placing a gate line and the first metal layer M1 between rows to align layers that are placeable on both sides.

8) Allowing the first metal layer M1 that connects a plurality of gates to intersect a gate alignment direction in order to minimize the use of gate layer wiring.

Routing execution conditions set to quickly determine the placement structure of the TRs are set as follows.

1) Minimizing the number of uses of routing for a specific metal line, e.g., the first metal layer M1. The specific metal line M1 refers to a channel.

2) Determining a space between metal layers based on an allowable spacing for the width of a metal line.

3) Using the second metal layer M2 when performing routing by skipping rows.

4) Defining the second metal layer M2 to be used when a pair with a 2D connection relationship is placed in different rows, and also defining the second metal layer M2 to be used when routing to the 0^{th} metal layer M0 is not possible in an independent TR routing step.

5) Routing the gate layer in the horizontal direction and using the vertical direction to maintain a minimum space between the gate layer and ISO (ISOlation).

6) Connecting external signals to the first metal layer M1 connected to an end of the gate layer.

In addition, to quickly determine the placement structure of the TRs, the present disclosure proposes using an estimated routing value of each TR. The present disclosure also proposes considering the following four factors to use estimated routing values of TRs.

First, a method of connecting two TRs is considered. This connection method includes three types. In a first type, short gates with relatively narrow gate widths of the two TRs are connected to each other. In a second type, a short gate of one TR is connected to a wide gate, source, or drain of the other TR. In a third type, the two TRs are connected in a manner different from the first and second types. Considering the connection method helps in determining the routing order, which may follow the sequence of the first type, the second type, and the third type. The short gate and the wide gate are distinguished based on the gate width. The short gate is defined as a gate with a width narrower than a preset reference gate, while the wide gate is defined as a gate with a greater width.

Second, rows in which the two TRs are placed are considered. For example, scenarios include placing the same TRs in the same row versus distributing the same TRs across different rows. Routing may be preferentially performed for a TR placed in a different row, with a lower priority given to a TR placed in the same row.

Third, the direction in which the gate widths of the two TRs extend is considered. For example, it is determined whether the gate width of the TR extends in the horizontal direction or in the vertical direction in the layout. Placement and routing may be set to be preferentially performed for a TR with a gate width extending in the horizontal direction, with the next priority given to a TR whose gate width extends in the vertical direction.

Fourth, it is considered whether TRs are placed in a single row or distributed across two rows. For example, scenarios include a TR placed in one row versus a TR split across two rows. Placement and routing may be preferentially performed for a TR split across two rows, with the next priority given to a TR placed in a single row.

In step 140, optimal TR placement and routing results are derived. Initially, TR placement and routing are performed according to the layout rules set in the heuristic rule setting step 130. Subsequently, the results from the first TR placement and routing are used as the basis for a second round of placement and routing, also following the layout rules from the heuristic rule setting step 130. This process is repeated, with each iteration refining the placement and routing based on the results of the previous iteration. A plurality of execution results are derived through this iterative process, and the optimal placement and routing results are derived by applying the evaluation of fitness function to each of the plurality of execution results.

A genetic algorithm used in the present disclosure to derive optimal TR placement and routing results in step 140 is an optimization technique based on the principles of natural selection and genetics, which are fundamental to evolution. This process includes selecting chromosomes from a population based on their fitness and generating a new population by applying genetic operators. The genetic algorithm optimizes by selecting and breeding genes that are well-adapted to a given environment, occasionally introducing mutations to ensure that desirable genetic traits are passed on to the next generation. As evolution continues, only the genes most suited to the environment are preserved.

Over several generations, the algorithm optimizes each TR, pattern, and pin pattern of the CCT pair and the center spacing of CC by repeatedly performing a selection process that prioritizes solutions with smaller fitness function values among several chromosome-based solutions, a crossover process between selected chromosomes, and a mutation process that introduces noise to chromosomal elements with a certain probability.

A fitness value is derived by evaluating an analytical function that calculates optimal resistance for the placement of two TR pairs. The present disclosure proposes to approximate the lower bound of the fitness value for evaluation purposes, allowing for the effective use of the evaluation function.

Accordingly, an initial selection of relatively excellent solution sets is made by comparing the lower bounds of the analysis function. The final optimal solution and routing components are then derived by evaluating the fitness function, which is calculated by a problem-solving program (solver) for candidate solutions that have been refined through a repeated fine-tuning process.

In such a case, various optimal solutions and routing components are derived from multiple perspectives. These perspectives include seven key factors such as TR deviation, capacitance, resistance, layout area, layout width, the number of metal layers, and the number of rows (height). The deviation refers to the variation (dispersion) in routing length, while capacitance and resistance refer to values that occur when connecting TRs.

The solutions generated based on the above-mentioned seven viewpoints may be freely selected according to the designer's design intentions.

In the result visualization step 150, the optimal TR placement and routing derived in step 140 are converted into data that can be visually confirmed. For example, the result visualization step 150 generates visual data or an actual layout file that compares a deviation ratio, capacitance, layout area, layout width, the number of metal layers, and the number of rows in the form of a table.

Although preferred embodiments of the present disclosure have been described in detail, the scope of the present disclosure is not limited thereto, and the present disclosure may be implemented as various embodiments based on the basic concept of the present disclosure defined in the following claims. Such embodiments also fall within the scope of the present disclosure.

What is claimed is:

1. A method for optimal placement and routing of transistors, comprising:
extracting parameters and connection information of transistors (TRs) from a netlist file;
generating an initial placement structure for the TRs based on mathematical model optimization using the parameters and connection information of the TRs;
setting heuristic rules, comprising layout rules for assigning work priorities to a common centroid transistor pair (CCT pair), TR pattern, and routing optimization, based on the initial placement structure; and
deriving optimal placement and routing results by performing TR placement and routing multiple times according to the layout rules, and applying an evaluation of fitness function to respective execution results.

2. The method of claim 1, wherein, in the generating of the initial placement structure, x and y coordinates are assigned to each TR pattern using the parameters of the TRs, y-axis positions of the TRs are aligned by introducing a degree of splitting of the TRs and a row concept, and mathematical variables based on the placement of the aligned TRs are applied, and the initial placement structure is primarily generated an estimated routing value for each TR, and
the mathematical variables comprise, when the TRs are aligned on a y-axis, a width and a length of gates of two TRs constituting a pair, a distance between TRs constituting two pairs implementing common centroid layout (CCL), a value corresponding to whether two rows are used, and a distance between rows.

3. The method of claim 2, wherein the generating of the initial placement structure complies with at least one of TR placement-related constraints comprising:
among TRs placed in a same row, matching coordinates of the TRs in a gate direction of a TR that has a maximum width;
when a two-dimensional (2D) TR pattern is used in the same row and the TR has a short gate length, defining a space with a neighboring TR;
ensuring that a gate length of a TR located to left and right of a common centroid transistor (CCT) is equal to a gate length of the CCT;
when a connection relationship exists, placing TRs located in different rows around a virtual line;
placing TRs that are not part of a common centroid layout in a finger structure; and
selecting whether to place a 2D common centroid (CC) pattern in two rows or one row based on a gate width of a TR.

4. The method of claim 3, wherein, in the generating of the initial placement structure, a 2D placement pattern is generated only when the number of TRs in a given netlist is a power of 2.

5. The method of claim 4, wherein, in the generating of the initial placement structure, when a gate width of a TR with the longest gate width in a unit placement group, which includes a plurality of TRs with different gate widths, is greater than or equal to a sum of gate widths of at least two TRs with shorter gate widths than the longest gate width plus a distance between the two TRs, a space between the two TRs is defined as a minimum space between gates, the two TRs being adjacent to the TR with the longest gate width and arranged in a direction of a gate width.

6. The method of claim 5, wherein, in the generating of the initial placement structure, when the longest gate width is smaller than the sum of gate widths of the at least two TRs plus the distance between the two TRs, the minimum space is defined based on whether a dummy pattern is addable to one side of one of the two TRs.

7. The method of claim 2, wherein setting the heuristic rules comprises:
assigning a priority to the CCT pair;
assigning a priority to a pair including an independent TR; and
assigning routing constraints.

8. The method of claim 7, wherein assigning the priority to the CCT pair comprises:
a first priority assignment of assigning the highest priority to a TR within a CCT pair that is clustered and surrounded in a same row and assigning a second priority to a TR located in another row among TRs paired with the TR assigned the highest priority; and
a second priority assignment of assigning a priority to TRs that have an adjacent connection relationship with a TR set that has already been optimized according to previously assigned priorities, among TRs that have not been assigned priorities, by applying the first priority assignment.

9. The method of claim 8, wherein, in each of the first priority assignment and the second priority assignment, after the highest and second priorities are assigned, when a tie occurs among TRs, a priority is sequentially assigned to a TR implemented in 2D and to a TR with a larger number of TR fragments among said TRs.

10. The method of claim 7, wherein, in the assigning a priority to a pair including an independent TR, the TRs are divided into a first group including a plurality of independent TRs requiring satisfaction of a routing deviation and a second group including a plurality of independent TRs not requiring the satisfaction of the routing deviation, a priority being assigned to the first group over the second group.

11. The method of claim 10, wherein, in the assigning a priority to a pair including an independent TR, a routing optimization priority is first assigned to TRs connected to a main TR and to TRs that include a larger number of TRs and a larger number of TR fragments in each of the first group and the second group, and
among the TRs connected to the main TR, a priority is assigned to TRs implemented in 2D within a same group.

12. The method of claim 7, wherein the assigning of the routing constraints complies with at least one of constraints comprising:
for routing pairs requiring pattern matching, matching the number of uses of routing and lengths of a gate layer and first and second metal layers;
matching a 0^{th} metal layer to a length within an allowable deviation;
determining in advance a location of a power line on a layout, and preventing metal lines, other than metal lines implementing the power line, from being installed on an upper layer or a lower layer where the power line is installed;
shielding external signals from other signals with high-speed frequencies;
installing a dummy line between metal lines to be matched with each other;
when alignment is difficult between two CCT pairs that need to be connected and pins, connecting the two CCT pairs by bending the 0th metal layer, which has a straight line shape at a certain angle;
placing a gate line and the first metal layer between rows to align layers that are placeable on both sides; and
allowing the first metal layer that connects a plurality of gates to intersect a gate alignment direction in order to minimize use of gate layer wiring.

13. The method of claim 12, wherein the assigning of the routing constraints further performs at least one of routing execution conditions comprising:
minimizing use of routing for a specific metal line;
determining a space between metal layers based on an allowable spacing for a width of a metal line;
using the second metal layer when performing routing by skipping rows;
defining the second metal layer to be used when a pair with a 2D connection relationship is placed in different rows and also defining the second metal layer to be used when routing to the 0^{th} metal layer is not possible in independent TR routing;
routing a gate layer in a first direction and using a second direction to maintain a minimum space between the gate layer and ISO (isolation), the second direction being perpendicular to the first direction; and
connecting external signals to the first metal layer connected to an end of the gate layer.

14. The method of claim 13, wherein the assigning of the routing constraints uses at least one of conditions using an estimated routing value between TRs and comprising:
considering a first type in which short gates with narrow gate widths of two TRs to be connected are connected to each other, a second type in which a short gate of one TR is connected to one of wide gate/source/drain of the other TR, and a third type in which the two TRs are connected in a manner different from the first and second types, and determining a routing order that follows a sequence of the first type, the second type, and the third type;
considering a case in which same TRs are placed in a same row and a case in which the same TRs are distributed across different rows, and setting routing to be preferentially performed for a TR placed in a different row and routing to be performed with a next priority given to a TR placed in the same row;
determining whether a direction in which a gate width of a TR extends in the first direction or in the second direction in a layout, and setting placement and routing to be preferentially performed for a TR whose gate width extends in the first direction and placement and routing to be performed with a next priority for a TR whose gate width extends in the second direction; and
determining a case in which one TR is placed in one row and a case in which one TR is split into two rows, and setting placement and routing to be preferentially performed for a TR split into the two rows and placement and routing to be performed with a next priority for a TR placed in one row.

15. The method of claim 2, wherein, in the deriving of the optimal TR placement and routing results, the optimal placement and routing results are derived using a genetic algorithm.

16. The method of claim 15, wherein the optimal placement and routing results are derived based on at least one of key factors including TR deviation, capacitance, resistance, layout area, layout width, the number of metal layers, or the number of rows.

17. The method of claim 1, further comprising:
a result visualization of converting the optimal placement and routing results into data that is visually confirmable.
